(19) United States
(12) Patent Application Publication
(10) Pub. No.: US 2007/0163396 A1
(43) Pub. Date: Jul. 19, 2007

(54) Connection device for connecting socket with pneumatic tools

(76) Inventor: Chih-Ching Hsieh, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/332,322

(22) Filed: Jan. 17, 2006

(51) Int. Cl. B25B 21/00; B25B 13/00

(52) U.S. Cl. 81/54; 81/124.4

(57) ABSTRACT

A socket has an insertion which includes a plurality of parallel first grooves and ridges on an outer periphery thereof and a pneumatic tool includes a rotatable driving end on a head thereof and the driving end has a recess with a plurality of second grooves and ridges defined in an inner periphery thereof. The insertion is slidably inserted into the recess and the first grooves and ridges of the insertion are engaged with the second grooves and ridges of the recess. A connection device secures the socket to the driving end, the connection device includes a protrusion and a receiving groove on either the insertion or the inner periphery of the recess such that the protrusion can be engaged with the receiving groove.

### FIELD OF THE INVENTION

The present invention relates to a connection device for conveniently connecting a socket to a pneumatic tool so that the socket is secured on the pneumatic tool.

### BACKGROUND OF THE INVENTION

A conventional way to connect a socket with a pneumatic tool generally includes a recess defined in the pneumatic tool and a socket includes an insertion which is inserted into the recess so that the socket can be driven by the pneumatic tool. The pneumatic tool includes a passage in which a bead and a spring are received, the bead is biased by the spring and partially protrudes out from the inner periphery of the recess. The insertion has a notch defined in an outer periphery thereof so that the bead can be engaged with the notch to position the socket and the socket is co-rotated with the pneumatic tool. However, the sockets easily drop from the recesses because there is no securing device for positioning the sockets with the recesses.

The present invention intends to provide a connection device for connecting a socket with a pneumatic tool wherein the socket or the inner periphery of the recess in the pneumatic tool has a protrusion and the inner periphery of the recess or the socket has an engaging hole for receiving the protrusion so that the socket is securely engaged with the recess.

### SUMMARY OF THE INVENTION

The present invention relates to a socket having a function end on a first end thereof and an insertion on a second end of the socket. The insertion includes a plurality of parallel first grooves and ridges on an outer periphery thereof. The pneumatic tool includes a barrel and a handle connected to the barrel, the barrel having a head which has a rotatable driving end. The driving end has a recess which has a plurality of second grooves and ridges defined in an inner periphery thereof. The insertion is slidably inserted into the recess and the first grooves and ridges of the insertion are engaged with the second grooves and ridges of the recess. A connection device secures the socket to the driving end.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the socket, the pneumatic tool and a first embodiment connection device of the present invention;

FIG. 2 is an exploded view to show the socket, the pneumatic tool and a second embodiment connection device of the present invention;

FIG. 3 is an exploded view to show the socket, the pneumatic tool and a third embodiment connection device of the present invention;

FIG. 4 is a side cross sectional view to show the first embodiment connection device of the present invention connects the socket to the pneumatic tool;

FIG. 5 is a side cross sectional view to show the second embodiment connection device of the present invention connects the socket to the pneumatic tool;

FIG. 6 is a side cross sectional view to show the third embodiment connection device of the present invention connects the socket to the pneumatic tool, and

FIG. 7 shows the pneumatic tool with the socket connected thereto and the a bolt is engaged with the socket.

### DETAILED DESCRIPTION OF THE PREFERRED EMBODIMENT

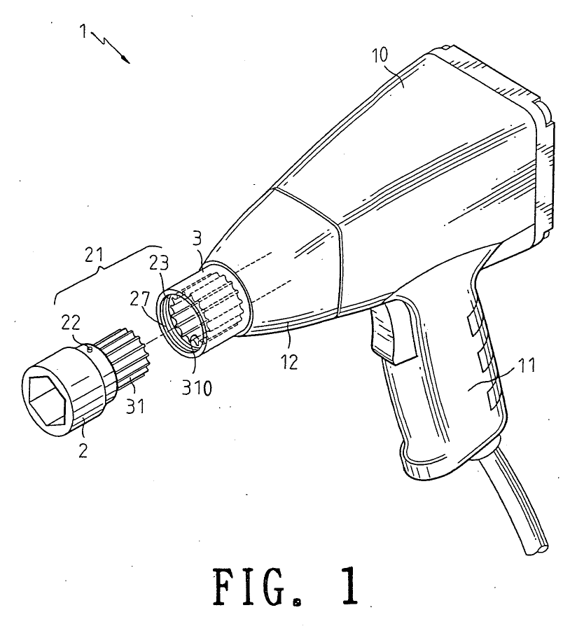

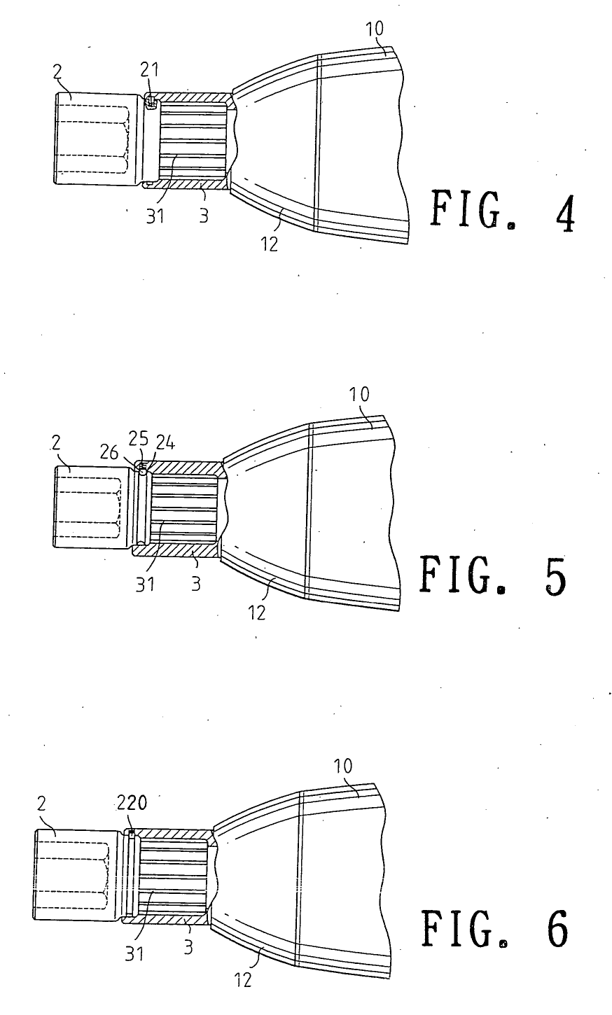

Referring to FIGS. 1 and 4, the socket 2 has a polygonal hole defined in a first end thereof and an insertion 31 extends from a second end of the socket 2. The insertion 31 includes a plurality of parallel first grooves and ridges on an outer periphery thereof.

The pneumatic tool 1 includes a barrel 10 and a handle 11 is connected to the barrel 10. A hose for introducing pressurized air is connected to the handle 11 and the barrel 10 is connected with a head 12 which has a rotatable driving end 3. The driving end 3 has a recess which has a plurality of second grooves and ridges 310 defined in an inner periphery thereof. The insertion 31 is slidably inserted into the recess and the first grooves and ridges of the insertion 31 are engaged with the second grooves and ridges 310 of the recess so that the socket 2 is driven by the driving end 3.

A connection device 21 secures the socket 2 to the driving end 3, and includes a protrusion 22 extending radially from the socket 2 and a receiving groove 23 is defined in the inner periphery of the recess. The protrusion 22 is removably engaged with the receiving groove 23. A C-shaped clip 27 is further engaged with the inner periphery of the recess so that the socket 2 can be secured with the recess of the pneumatic tool 1.

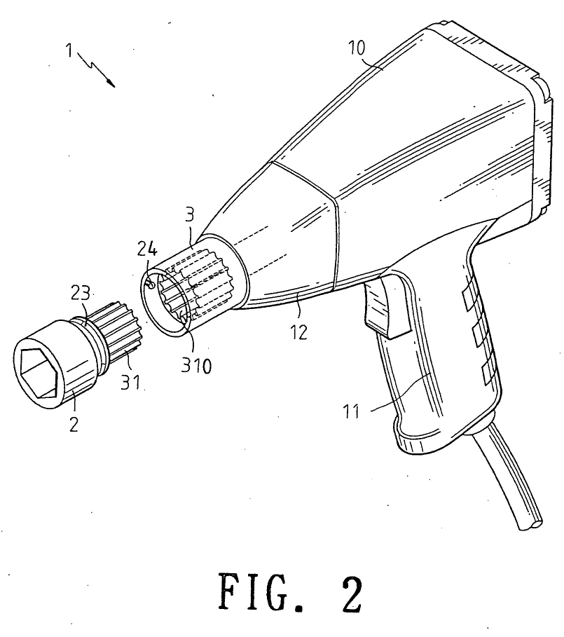

As shown in FIGS. 2 and 5, a second embodiment of the connection device 21 includes a receiving notch 24 defined in the inner periphery of the recess and a bead 26 and a spring 25 are received in the receiving notch 24. The bead 26 partially protrudes from the receiving notch 24. The insertion 31 has a receiving groove 23 defined in the outer periphery thereof. The bead 26 is removably engaged with the receiving groove 23.

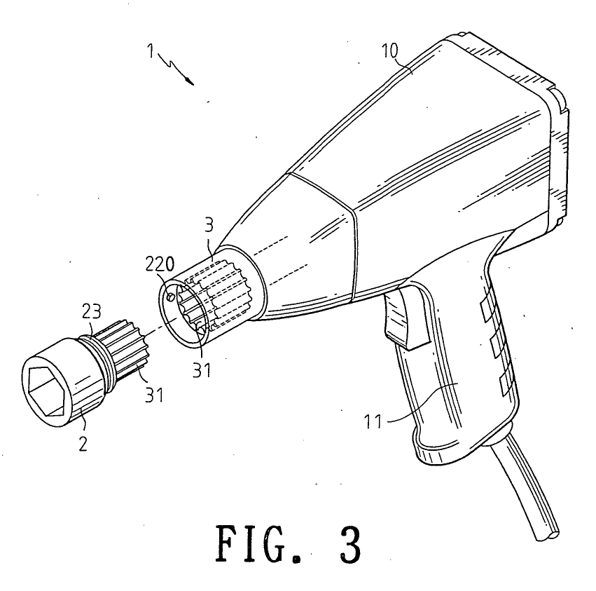

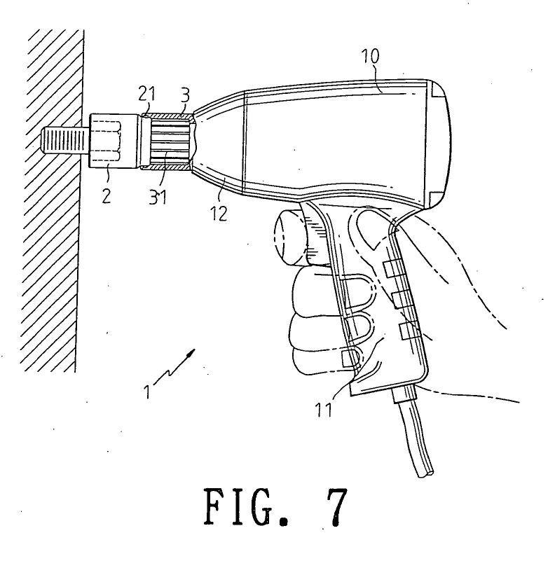

As shown in FIGS. 3 and 6, a third embodiment of the connection device 21 includes a receiving groove 23 defined in the outer periphery of the insertion 31 and a protrusion 220 extends radially inward from the inner periphery of the recess. The protrusion 220 is removably engaged with the receiving groove 23.

While we have shown and described the embodiment in accordance with the present invention, it should be clear to those skilled in the art that further embodiments may be made without departing from the scope of the present invention.

What is claimed is:

1. A combination of a socket and a pneumatic tool, wherein the socket 2 has a polygonal hole defined in a first end thereof and an insertion 31 on a second end of the socket 2, the insertion 31 includes a plurality of parallel first grooves and ridges on an outer periphery thereof, the pneumatic tool includes a barrel 10 and a handle 11 connected to the barrel 10, the barrel 10 has a head 12 which has a rotatable driving end 3, the driving end 3 has a recess which has a plurality of second grooves and ridges 310 defined in an inner periphery thereof, the insertion 31 is slidably inserted into the recess and the first grooves and ridges of the insertion 31 are engaged with the second grooves and ridges 310 of the recess, and
a connection device 21 securing the socket 2 to the driving end 3.

2. The combination as claimed in claim 1, wherein the connection device 21 includes a protrusion 22 extending radially from the socket 2 and a receiving groove 23 is defined in the inner periphery of the recess, the protrusion 22 is removably engaged with the receiving groove 23.

3. The combination as claimed in claim 2, wherein a C-shaped clip 27 is engaged with the inner periphery of the recess.

4. The combination as claimed in claim 1, wherein the connection device 21 includes a receiving notch 24 defined in the inner periphery of the recess and a bead 26 and a spring 25 are received in the receiving notch 24, the bead 26 partially protrudes from the receiving notch 24, the insertion 31 has a receiving groove 23 defined in the outer periphery thereof, the bead 26 is removably engaged with the receiving groove 23.

5. The combination as claimed in claim 1, wherein the connection device 21 includes a receiving groove 23 defined in the outer periphery of the insertion 31, a protrusion 220 extends radially inward from the inner periphery of the recess, the protrusion 220 is removably engaged with the receiving groove 23.
